(19) United States
(12) Patent Application Publication
(10) Pub. No.: US 2025/0105296 A1
(43) Pub. Date: Mar. 27, 2025

(54) Cathode with a Fluorine-Containing Polymer, and Solid-State Battery Comprising the Cathode

(71) Applicant: Bayerische Motoren Werke Aktiengesellschaft, Muenchen (DE)

(72) Inventors: Juliane KLUGE, Oxford (GB); Raimund KOERVER, Muenchen (DE); Sebastian SCHARNER, Tuerkenfeld (DE)

(21) Appl. No.: 18/709,893

(22) PCT Filed: Nov. 11, 2022
(86) PCT No.: PCT/EP2022/081573

§ 371 Date: May 14, 2024

(30) Foreign Application Priority Data
Dec. 1, 2021 (DE) 10 2021 131 511.5

(51) Int. Cl. H01M 4/62; H01M 4/02

(52) U.S. Cl. CPC H01M 4/623; H01M 2004/028

(57) ABSTRACT

A cathode for a solid-state battery is provided. The cathode includes the following components: (A) at least one cathode active material; and (B) at least one first fluorine-containing polymer with an at least partly fluorinated or perfluorinated base structure. The first fluorine-containing polymer contains at least one ionic group of the formula (I), wherein M is a cation selected from the group consisting of protons and alkali metals, n is a whole number from 1 to 4, Z represents a central ion selected from the group consisting of aluminum and boron, and R represents a monovalent and optionally fluorine-substituted hydrocarbon group which is selected from the group consisting of C₁-C₈ alkyl, C₂-C₁₀-alkenyl, C₂-C₁₀ alkinyl, C₆-C₁₂-cycloalkyl, and C₆-C₁₂ aryl. The ionic group is connected to the base structure of the first fluorine-containing polymer via at least one bridging oxygen atom of the ionic group.

### BACKGROUND AND SUMMARY

The invention relates to a cathode and to a solid-state battery including the cathode.

The term “solid-state battery” is used synonymously hereinafter for all terms commonly used in the art for galvanic elements and cells that use at least one solid-state electrolyte as ion-conducting connection between cathode and anode, for example solid-state metal battery, solid-state metal accumulator, all-solid-state battery (ASSB), cell, solid-state cell, polymer cell and accumulator. In particular, rechargeable batteries (secondary batteries) are included. The terms “battery”, “cell” and “electrochemical cell” are also used synonymously with the term “solid-state battery”.

Solid-state batteries are a further development of batteries having liquid electrolytes. The porous, liquid-impregnated separator intended for ion transport and hence for balancing of charge between cathode and anode is replaced here by an ion-conducting solid.

A preferred embodiment of the solid-state battery is the lithium ion solid-state battery.

Solid-state lithium ion batteries known from the art have two different electrodes: a positive electrode (cathode) and a negative electrode (anode). In a solid-state lithium ion battery, the cathode includes an active cathode material which is capable of reversibly taking up and releasing lithium ions. The anode may include an active anode material, where the active anode material includes either lithium metal, a lithium-containing alloy or an alternative material which is likewise intended to reversibly take up and release lithium ions. Materials that are customary in the art are, for example, graphite, silicon and silicon suboxide (SiOₓ, with 0<x<2).

If the anode does not contain any lithium metal immediately after the production of the solid-state lithium ion battery, but at least partial deposition of lithium metal takes place in the first charging operations, this is called a “lithium-free” anode concept. What is meant by “lithium-free” in this connection is that the anode in the uncharged state after production and before formation of the cell is free of metallic lithium. The metallic lithium is only formed by a corresponding charging operation at the anode.

The two electrodes are connected to one another in a lithium ion-conducting manner via a solid-state separator. In addition, the solid-state separator spatially separates the cathode from the anode. The solid-state separator assures lithium ion transport between the cathode and the anode. The solid-state separator thus conducts the electrical current via lithium ion transport within the solid. The solid-state separator thus constitutes a solid-state lithium ion conductor.

Solid-state separators can be classified into ceramic, polymer-based and gel-based solid-state electrolytes. Ceramic solid-state electrolytes used are especially sulfidic and oxidic solid-state electrolytes, and these are becoming ever more important because of their electrochemical stability with simultaneously high lithium ion conductivity. By contrast, polymer-based solid-state electrolytes are solvent-free and are based on the conduction of ions along polymer chains. A polymer-based solid-state electrolyte used may, for example, be polyethylene oxide admixed with a lithium-containing conductivity additive. Gel-based solid-state electrolytes contain a solid polymer matrix permeated by a liquid electrolyte that assures ion conduction.

US 2019/0157723 A1 describes a solid-state lithium ion battery containing a cathode with an active cathode material and an anode with an active anode material. In addition, the anode comprises an anode current collector. The active anode material is chosen such that it can form an alloy or a compound with metallic lithium. The active anode material and the active cathode material are spatially separated from one another by a solid-state electrolyte. The solid-state electrolyte consists of a sulfidic material, such as Li₆PS₅Cl with argyrodite structure. The active cathode material especially consists of known lithium-containing layered oxides such as NMC. The active anode material may be selected from the group consisting of amorphous carbon, gold, platinum, palladium, silicon, silver, aluminum, bismuth, tin and zinc, and combinations thereof.

The above-described solid-state lithium ion battery uses a lithium-free anode concept since, during the first charging operations, metallic lithium is deposited between the anode current collector and the active anode material. The metallic lithium is thus not present at first in the cell after the production.

WO 2020 0725524 A1 discloses a solid-state lithium ion battery comprising an anode current collector, a solid-state electrolyte and a transition layer between the anode current collector and the solid-state electrolyte. The transition layer is selected from the group consisting of zinc, tin, magnesium, silver, aluminum, indium, bismuth, lithium alloy, lithium oxide and lithium peroxide, and combinations thereof. In particular, the solid-state electrolyte consists of a lithium-containing garnet, preferably of lithium lanthanum zirconate (LLZO) with the chemical formula Li₇La₃Zr₂O₁₂, which assures balancing of charge between the cathode and anode by the transport of lithium ions. Here too, a lithium-free anode concept is again employed.

US 2021/0126281 A1 discloses ceramic solid-state electrolytes that can be described by the general formula:

Li_{1-a-b-c-d}PₐT_{b}A_{c}X_{d}

where 0≤a≤0.129, 0≤b≤0.096, 0.316≤c≤0.484, 0.012≤d≤0.125, and in which T denotes an element from the group consisting of As, Si, Ge, Al and B, X denotes one or more halogens or N, and A is one or more of S and Se.

WO 2019/051305 A1 discloses a cathode, anode and a solid-state electrolyte disposed between the cathode and the anode. At least the cathode, anode or the solid-state electrolyte comprises a ceramic material comprising lithium (Li), boron (B) and sulfur(S). The ceramic material shows a plurality of crystalline phases and has an overall composition characterized by a molar a:b:c ratio of Li:B:S where c/b is within a range from about 1 to about 3.

EP 3 496 202 A1 describes lithium ion-conducting lithium yttrium halides of the general formula Li_{6-3z}Y_{z}X₆ in which 0<z<2 and X denotes Cl or Br. The lithium yttrium halides are used as solid-state electrolyte in a solid-state lithium ion battery.

U.S. Pat. No. 10,811,688 B2 and US 2017/0338492 A1 disclose a solid-state lithium ion battery with a solid-state electrolyte based on an ion-conducting polymer, an ion source such as Li₂O, Na₂O, MgO, CaO, ZnO, KOH, NaOH, CaCl₂), AlCl₃, MgCl₂, LiTFSI (lithium bis(trifluoro-methanesulfonimide)), LiBOB (lithium bis(oxalate) borate) or combinations thereof, and an electron acceptor. Lithium ion-conducting polymers specified are liquid-crystal polymers, polyetheretherketone (PEEK), polyphenylene sulfide (PPS) and semi crystalline polymers having a crystallinity of more than 30%.

US 2019/0051939 A1 discloses a solid-state lithium ion battery containing a polylithium acrylate as polymer-based solid-state electrolyte. The solid-state electrolyte further comprises a hydrophilic polymer, a lithium salt and a lewis acid.

In order to assure sufficient conduction of ions between electrode and solid-state electrolyte, there must be intimate contact between the active materials of the cathode and the solid-state electrolyte. For this purpose, the solid-state electrolyte is also integrated into the cathode. This is accomplished by provision of what are called composite electrodes, i.e., a mixture of the solid-state electrolyte and the active material.

However, the combination of solid-state electrolyte and active cathode material entails a number of problems.

In regular operation of a solid-state lithium ion battery, constant re- and de-lithiation of the active materials can result in changes in volume within these materials. These changes in volumes can lead to mechanical stresses in the cell over a prolonged period of time. The mechanical stresses can in turn give rise to cracks within the solid-state electrolyte, which can impair the proper operation of the cell. Cracking is a problem for rigid ceramic solid-state electrolytes in particular.

Moreover, ceramic solid-state electrolytes frequently require a sintering step in production at temperatures between 650° and 1200°. However, such temperatures can irreversibly damage a composite cathode, especially the active cathode material present in the composite cathode.

A remedy can be provided either by organic binders or polymer electrolytes such as polyethylene oxide (PEO) in the cathode composite. However, organic binders lack ionic conductivity, and, in the case of polymers such as PEO, oxidative stability is often insufficient for the potentials of the electrode materials on the cathode side (>4 V).

It is an object of the invention to avoid the disadvantages of the solid-state batteries known from the art and to provide a solid-state battery that is easy to produce and can be operated stably over a prolonged period.

The object is achieved in accordance with the invention by the providing of a cathode for a solid-state battery according to claim 1.

Advantageous embodiments of the cathode of the invention for a solid-state battery are specified in the dependent claims, which can be combined with one another as desired.

According to the invention, the cathode for a solid-state battery comprises the following components:
(A) at least one active cathode material;
(B) at least one first fluorine-containing polymer having an at least partly fluorinated or perfluorinated base skeleton, where the first fluorine-containing polymer contains at least one ionic group of the following formula (I):

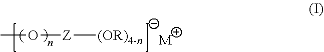

in which
   M is a cation selected from the group consisting of proton and alkali metals;
   n is an integer from 1 to 4;
   Z denotes a central ion selected from the group consisting of aluminum and boron; and
   R represents a monovalent, optionally fluorine-substituted hydrocarbyl radical and is selected from the group consisting of C₁-C₈-alkyl, C₂-C₁₀-alkenyl, C₂-C₁₀-alkynyl, C₆-C₁₂-cycloalkyl and C₆-C₁₂-aryl;
where the ionic group is bonded to the base skeleton of the first fluorine-containing polymer via at least one bridging oxygen atom in the ionic group.

The invention is based on the basic concept of providing a combination of an active cathode material and a first fluorine-containing polymer for the cathode of a solid-state battery, where the combination proposed in accordance with the invention has a number of advantageous properties.

The fluorine-containing polymer has ionic groups as an essential feature. The ionic groups enable virtually unhindered ion transport within the cathode. The first fluorine-containing polymer is thus an ion conductor. There is therefore no need to add conventional conductive salts, for example lithium hexafluorophosphate. Ions are conducted via the fluorine-containing polymer. Because of these functional ionic groups, the first fluorine-containing polymer also has a transference number close to 1.

At the same time, fluorine-containing polymers having an at least partly fluorinated or perfluorinated base skeleton have high chemical and electrochemical stability. Consequently, these are particularly suitable for use in a cathode for a solid-state battery.

The first fluorine-containing polymer is additionally mechanically flexible and elastic. The polymers are therefore able to compensate for the changes in volume of the active cathode material during cell operation. The active cathode material can thus expand and contract again unhindered during re- and de-lithiation. The combination of active cathode material and the first fluorine-containing polymer can compensate for these changes in volume and prevent mechanical stresses within the cell.

In addition, a synergistic effect arises between the active cathode material as “rigid” component and the fluorine-containing polymer as “flexible” component. The fluorine-containing polymer as “flexible” component can preferably adapt to the rigid shape of the active cathode material. As a result, it is possible to increase the contact area, and ion conduction between the fluorine-containing polymer and the active cathode material is thus assured.

Suitable active cathode materials for the cathode may be any of the active cathode materials known in the art.

Preferred active cathode materials for the cathode of the invention include lithium cobalt oxide (LCO), lithium nickel oxide (LNO), lithium nickel cobalt aluminum oxide (NCA), lithium nickel manganese cobalt oxide (NMC), lithium- and manganese-rich lithium nickel manganese cobalt oxide or lithium nickel manganese oxide (LMR), lithium manganese oxide (LMO), lithium iron phosphate (LFP), lithium manganese iron phosphate (LMFP), lithium nickel manganese oxide spinel (LNMO) and derivatives and combinations thereof.

Lithium-nickel-manganese-cobalt compounds are also known by the abbreviation NMC, and occasionally also alternatively by the technical abbreviation NCM. NMC-based cathode materials are used especially in lithium ion batteries for vehicles. NMC as cathode material has an advantageous combination of desirable properties, for example high specific capacity, reduced cobalt content, high high-current capacity and high intrinsic safety, which is manifested, for example, in sufficient stability in the event of an overload.

NMCs may be described by the general formula unit Li_{α}NiₓMn_{y}Co_{z}O₂ with x+y+z=1, where α denotes the number of the stoichiometric proportion of lithium and is typically between 0.8 and 1.15. Particular stoichiometries are specified as three-figure numbers in the literature, for example NMC 811, NMC 622, NMC 532 and NMC 111. The three-figure number in each case specifies the relative content of nickel: manganese:cobalt. In other words, for example, NMC 811 is a cathode material having the general formula unit LiNi_{0.8}Mn_{0.1}Co_{0.1}O₂, i.e. with α=1. In addition, it is also possible to use what are called lithium- and manganese-rich NMCs or LMR with the general formula unit Li_{1+ε}(NiₓMn_{y}Co_{z})_{1-ε}O₂, where ε is in particular between 0.1 and 0.6, preferably between 0.2 and 0.4. These lithium-rich layered oxides are also known as overlithiated (layered) oxides (OLOs).

According to the invention, the first fluorine-containing polymer contains at least one ionic group of the general formula (I).

The ionic group is an ion comprising a cation M⁺ and an anion

[—(O)ₙ—Z—(OR)₄₋ₙ]⁻.

In the general formula (I), the negative charge of the anion is balanced stoichiometrically by the positive charge of the cation.

The cation is selected from the group consisting of proton and alkali metals. The cation is preferably lithium.

Z in the formula (I) denotes a central ion selected from the group consisting of aluminum and boron. The ionic groups are thus either aluminates or borates, and the anions of the formula (I) are correspondingly singly negatively charged.

The R radicals represent respectively monovalent, optionally fluorine-substituted hydrocarbyl radicals and are independently selected from the group consisting of C₁-C₈-alkyl, C₂-C₁₀-alkenyl, C₂-C₁₀-alkynyl, C₆-C₁₂-cycloalkyl and C₆-C₁₄-aryl. In the context of the invention, what is meant by monovalent is that the hydrocarbyl radicals R each bind to the central ion Z via a single oxygen atom.

The expression C₁-C₈-alkyl in the context of the invention encompasses linear or branched saturated hydrocarbyl radicals having one to eight carbon atoms. Preferred hydrocarbyl radicals include, for example, methyl, ethyl, n-propyl, isopropyl, n-butyl, sec-butyl, isobutyl, tert-butyl, n-pentyl, isopentyl, 2,2-dimethylpropyl, n-hexyl, isohexyl, 2-ethylhexyl, n-heptyl, isoheptyl, n-octyl and isooctyl.

The expression C₂-C₁₀-alkenyl in the context of the invention encompasses linear or branched, at least partly unsaturated hydrocarbyl radicals having two to ten carbon atoms, where the hydrocarbyl radicals have at least one C—C double bond. Preferred hydrocarbyl radicals include, for example, ethenyl, 1-propenyl, 2-propenyl, 1-n-butenyl, 2-n-butenyl, isobutenyl, 1-pentenyl, 1-hexenyl, 1-heptenyl, 1-octenyl, 1-nonenyl and 1-decenyl.

The expression C₂-C₁₀-alkynyl in the context of the invention encompasses linear or branched, at least partly linear unsaturated hydrocarbyl radicals having two to ten carbon atoms, where the hydrocarbyl radicals have at least one C—C triple bond. Preferred hydrocarbyl radicals include, for example, ethynyl, 1-propynyl, 2-propynyl, 1-n-butynyl, 2-n-butynyl, isobutynyl, 1-pentynyl, 1-hexynyl, 1-heptynyl, 1-octynyl, 1-nonynyl and 1-decynyl.

The expression C₆-C₁₂-cycloalkyl in the context of the invention encompasses cyclic, saturated hydrocarbyl radicals having six to twelve carbon atoms. Preferred hydrocarbyl radicals include, for example, cyclopropyl, cyclobutyl, cyclopentyl, cyclohexyl, cycloheptyl, cyclohexyl, cyclononyl and cyclodecanyl.

The expression C₆-C₁₄-aryl in the context of the invention encompasses aromatic hydrocarbyl radicals having six to twelve carbon atoms. Preferred hydrocarbyl radicals include, for example, phenyl, naphthyl and anthracyl.

In a preferred embodiment, the hydrocarbon radicals R are at least partly fluorine-substituted, preferably fully fluorine-substituted.

Fluorine-substituted hydrocarbyl radicals result in anions that form particularly stable ionic groups of the formula (I).

n is an integer from 1 to 4. n thus defines a number of bonds of the central ion Z to the at least partly fluorinated or perfluorinated base skeleton of the first fluorine-containing polymer. The central ion Z is always bonded to the first fluorine-containing polymer via at least one bridging oxygen atom of the ionic group.

The number of —OR radicals in the general formula (I) is specified as 4-n. Thus, the number of —OR radicals is coupled directly to the number of bonds (n) of the central ion Z to the at least partly fluorinated or perfluorinated base skeleton of the first fluorine-containing polymer.

Depending on n, it is possible to adjust the degree of linkage of the ionic group. In general, two types of linkage are possible via the choice of n: ionic end groups (n=1); and ionic crosslinking groups (n=2, 3 or 4).

In one embodiment, the first fluorine-containing polymer includes at least one ionic end group of the general formula (I) in which n is 1.

If n in formula (I) corresponds to 1, the central ion Z is bonded to the base skeleton of the first fluorine-containing polymer via a bridging oxygen atom in the ionic group. Such a central ion Z then binds to three-OR radicals. One example of such an ionic end group is given by the following formula (II):

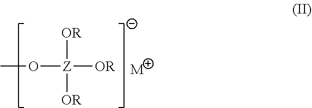

In a further embodiment, the first fluorine-containing polymer has at least one ionic crosslinking group of the general formula (I) in which n is 2, 3 or 4.

If n in formula (I) corresponds to 2, the central ion Z is bonded to the base skeleton of a first fluorine-containing polymer via two bridging oxygen atoms in the ionic group. Such a central ion Z then binds to two-OR radicals. One example of such an ionic structure is given by the following formula (III):

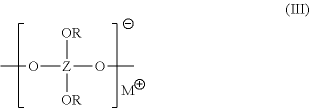

If n in formula (I) corresponds to 3, the central ion Z is bonded to the base skeleton of a first fluorine-containing polymer via three bridging oxygen atoms in the ionic group. Such a central ion Z then binds to one-OR radical. One example of such an ionic structure is given by the following formula (IV):

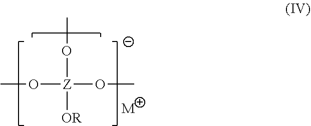

If n in formula (I) corresponds to 4, the central ion Z is bonded to the base skeleton of a first fluorine-containing polymer via four bridging oxygen atoms in the ionic group. Such a central ion Z does not bind to any-OR radicals. One example of such an ionic structure is given by the following formula (V):

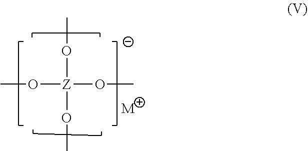

In general, the first fluorine-containing polymer may have both ionic end groups of the formula (II) and ionic crosslinking groups of the formulae (III) to (V). However, it is also conceivable that the first fluorine-containing polymer contains solely ionic end groups or solely ionic crosslinking groups.

In a preferred embodiment, the general formula (I) has at least one or more than one of the following features: Z denotes aluminum; M denotes lithium; and R represents a linear, branched or cyclic C₁-C₄-perfluoroalkyl radical.

The expression C₁-C₄-perfluoroalkyl in the context of the invention encompasses linear or branched saturated perfluorinated hydrocarbyl radicals having 1 to 4 carbon atoms.

Examples of suitable perfluoroalkyl radicals are trifluoromethyl, perfluoroethyl, perfluoropropyl, perfluoroisopropyl, perfluoro-n-butyl, perfluoro-sec-butyl, perfluoroisobutyl and perfluoro-tert-butyl.

In a particularly preferred embodiment, the ionic group is an ionic end group of the following formula (VI):

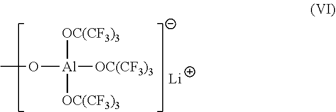

In one embodiment, the base skeleton of the first fluorine-containing polymer is fully fluorinated and has repeat units of tetrafluoroethylene (—C₂F₄—). The base skeleton of the first fluorine-containing polymer thus derives from polytetrafluoroethylene (PTFE). In addition, the base skeleton is unbranched (linear) and consists essentially of fluorine and carbon.

The first fluorine-containing polymer may comprise at least one perfluorinated side chain. The perfluorinated side chain serves for linkage of the base skeleton and an ionic group of the general formula (I).

The invention is not restricted in relation to the perfluorinated side chain. It is possible to use any of the perfluorinated side chains known in the art for perfluorinated polymers. In particular, it is possible to use the perfluorinated side chains known from DE 28 17 315, to which reference is made here.

In a preferred embodiment, the base skeleton of the first fluorine-containing polymer contains at least one side chain of the following formula (VII):

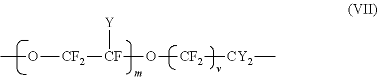

in which
   Y denotes a fluorine atom or a linear, branched or cyclic C₁-C₈ perfluoroalkyl radical;
   m is 0, 1 or 2; and
   v is 0 or 1;
where the ionic group of the general formula (I) is bonded to the CY₂ radical of the side chain.

The central ion Z of an ionic group of the general formula (I) may be bonded here to the CY₂ radical of the side chain via a bridging oxygen atom of the ionic group. The side chain thus constitutes a linking element between the base skeleton and the ionic group.

An ionic end group is bonded merely via one side chain to the base skeleton of the first fluorine-containing polymer. Ionic crosslinking groups are instead bonded to a base skeleton of a fluorine-containing polymer via two or more side chains. However, it is also conceivable that the ionic crosslinking groups crosslink the base skeletons of two or more first fluorine-containing polymers to one another.

If, for example, in the general formula (I), n corresponds to 2, the ionic crosslinking group is bonded to the base skeleton of a first polymer via two side chains.

In a further embodiment, the first fluorine-containing polymer is a copolymer of the following formula (VIII) or (IX):

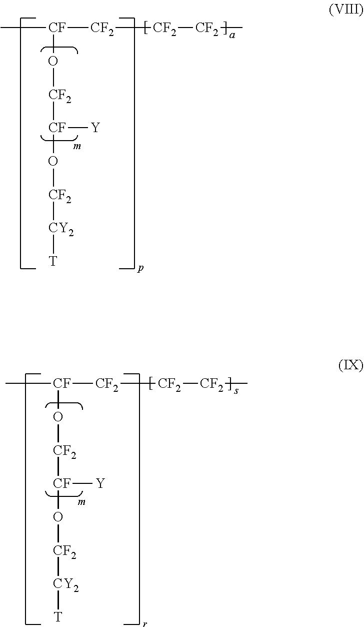

in which
   m is 0, 1 or 2;
   p is 1 to 10;
   r is 1 to 10;
   s is 1 to 15; and
   Y denotes a fluorine atom or a linear, branched or cyclic C₁-C₁₀-perfluoroalkyl radical; and
   T represents an ionic group of the general formula (I).

Here too, the ionic group T of the general formula (I) is bonded to the —CY₂ radical. The ionic group of the general formula (I) can thus be integrated in a simple manner into the fluorine-containing polymer.

Furthermore, the side chains, because of the fluorine substitution, are chemically stable to the oxidative stresses during the operation of the cell.

The first fluorine-containing polymer can be prepared via the synthesis of hydroxyl group-containing fluoropolymers, which can be reacted in the presence of perfluoroalcohols with lithium aluminum hydride (LiAlH₄) in perfluorohexane (C₆F₁₄) at 70-80° C. The cathode may also comprise a second fluorine-containing polymer, where the second fluorine-containing polymer is selected from the group of the sulfonated perfluorinated polymers.

In relation to the sulfonated perfluorinated polymers, the invention is not subject to any further restriction. In principle, it is possible to use any of the sulfonated perfluorinated polymers that are customary in the art.

For example, it is possible to use the polymers known from DE 28 17 315.

In a preferred embodiment, the sulfonated perfluorinated polymers are based on or derived from polytetrafluoroethylene such as NAFION®.

In further embodiments, the sulfonated perfluorinated polymers have perfluoroalkyl side chains having functional groups.

In relation to the functional groups of the perfluoroalkyl side chains, the second fluorine-containing polymer is unrestricted. In principle, it is possible to use any of the functional groups customary in the art for perfluoroalkyl side chains, provided that they are ionic and have lithium ions as cations.

The sulfonated perfluorinated polymers based on polytetrafluoroethylene preferably have SO₃Li-containing, SO₂—N⁻Li⁺—SO₂CF₃-containing and/or SO₂C(CN)₂Li-containing perfluoroalkyl side chains.

Suitable examples of SO₂C(CN)₂Li-containing perfluoroalkyl side chains are structures of the following formula (X):

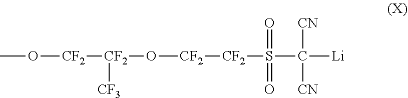

Suitable examples of SO₃Li-containing perfluoroalkyl side chains are structures of the following formula (XI):

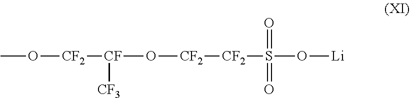

Suitable examples of SO₂—N⁻Li⁺—SO₂CF₃-containing perfluoroalkyl side chains are structures of the following formula (XII):

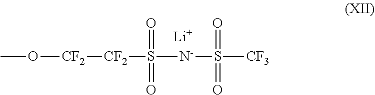

The perfluoroalkyl side chains are not restricted in relation to the abovementioned examples, especially not to the perfluoroethoxy and perfluoroisopropoxy groups shown. In principle, the SO₃Li-containing, SO₂—N⁻Li⁺—SO₂CF₃-containing and/or SO₂C(CN)₂Li-containing perfluoroalkyl side chains proposed may have any branched or unbranched perfluoroalkoxy groups.

It is preferably possible via the introduction of a second fluorine-containing polymer to specifically adjust the lithium content of the cathode. In addition, it is also possible to adjust the lithium ion conductivity of the cathode. The lithium ion conductivity is adjusted primarily via the choice of functional group of the perfluoroalkyl side chains. Thus, the second fluorine-containing polymer is a second lithium ion conductor.

In a preferred embodiment, the cathode comprises at least one solvent component, where the solvent component is selected from the group consisting of perfluorocarbonates, perfluoroaromatics, perfluoroethers and perfluoroesters, and combinations and derivatives thereof.

A perfluoroaromatic used may, for example, be hexafluorobenzene.

More preferably, the solvent component forms a gel together with the first and/or second fluorine-containing polymer. The gel fulfills the function of a gel electrolyte, with the task of assuring ion transport in the cathode. The gel electrolyte is mechanically flexible, which means that this can compensate for the change in volume of the active cathode material during cell operation. Damage to the solid-state cell on account of mechanical stresses can thus be avoided.

In a particularly preferred embodiment, the cathode comprises the following components, based in each case on the total weight of the cathode:
(A) 40-98% by weight of at least one active cathode material;
(B) 0.1-30% by weight of at least one first fluorine-containing polymer;
(C) 0-30% by weight of at least one second fluorine-containing polymer, preferably selected from the group of the sulfonated perfluorinated polymers, preferably from the derivatives of polytetrafluoroethylene (PTFE) having SO₃Li-containing, SO₂—N-Lit-SO₂CF₃-containing and/or SO₂C(CN)₂Li-containing perfluoroalkyl side chains; and
(D) 0-70% by weight, preferably 0.1-70% by weight, of at least one solvent component consisting of perfluorocarbonates, perfluoroaromatics, perfluoroethers and perfluoroesters, and combinations and derivatives thereof;
where the proportions of components (A) to (D) add up to 100% by weight.

In addition, the cathode may contain further additions as known from the art, for example binders and conductivity additives. The invention is not restricted with regard to the further additions.

In addition, the invention relates to a solid-state battery having a cathode, an anode and a solid-state separator that spatially separates the cathode from the anode and is in ion-conducting contact with the cathode and anode.

The solid-state separator comprises at least one ceramic polymer-based or gel-based solid-state electrolyte or combinations thereof.

The invention is not restricted with regard to the solid-state electrolytes used as solid-state separator. In principle, it is possible to use any of the separators based on solid-state electrolytes that are known in the art.

The solid-state separator may comprise at least one solid-state electrolyte, especially at least one ceramic, polymer-based or gel-based solid-state electrolyte, and combinations thereof.

In one embodiment, the solid-state electrolyte comprises a lithium phosphorus sulfide and/or a lithium boron sulfide having the general formula Li_{c}T_{y}S_{z}R_{q} in which T denotes boron or phosphorus, and R denotes a halogen, and where 2≤c≤7, 1≤y≤7, 3≤z≤13, 0≤ q≤1.

Further examples of suitable solid-state electrolytes include the compounds, known from US 2021/0126281 A1, of the general formula:

Li_{1-a-b-c-d}PₐT_{b}A_{c}X_{d}
where 0≤a≤0.129, 0≤b≤0.096, 0.316≤c≤0.484, 0.012≤d≤0.125, and in which T denotes an element from the group consisting of As, Si, Ge, Al and B, X denotes one or more halogens or N, and A is one or more of S and Se, and the compositions known from WO 2019/051305 A1 that are based on lithium (Li), boron (B) and sulfur(S) and are characterized by a molar a:b:c ratio of Li:B:S, where c/b is within a range from about 1 to about 3.

In another embodiment, the solid-state electrolyte comprises a lithium-containing garnet having the general formula LiₙLaₘM′ₚM″_{q}ZrₛOₜ in which 4<n<8.5, 1.5<m<4, 0<p≤2, 0≤q≤2, 0≤s≤2.5 and 10<t≤13, and where M′ and M″ are independently selected from the group consisting of aluminum, molybdenum, tungsten, niobium, antimony, calcium, barium, strontium, cerium, hafnium, rubidium, gallium and tantalum.

In one development of the invention, the lithium-containing garnet comprises a compound having the general formula Li_{w}LaᵥZrₖOₕ·gAl₂O₃ in which 5≤w≤8, 2≤v≤5, 0≤ k≤3, 10≤h≤13 and 0≤g≤1.

In a preferred embodiment, the solid-state electrolyte is a lithium-containing garnet having the general formula LiⱼLa₃Zr_{b}O₁₂·gAl₂O₃ in which 5≤j≤8, 0<b≤2.5, and 0≤ g≤1.

Polymer-based solid-state electrolytes used may especially be mixtures of polyethylene oxide and derivatives thereof with a lithium-containing conductive salt. Further examples include ion-conducting polymers based on liquid-crystal polymers, polyetheretherketone (PEEK), polyphenylene sulfide (PPS) and semicrystalline polymers have a crystallinity of more than 30%, such as the compositions known from US 2017/0338492 A1 and U.S. Pat. No. 10,811,688 B2, to which reference is made.

In addition, it is also possible to use the solid-state electrolytes known from US 2019/0051939 A1, which contain a polylithium acrylate together with a hydrophilic polymer, a lithium salt and a Lewis acid.

Furthermore, it is possible to use the lithium ion-conducting lithium yttrium halides of the general formula Li_{6-3z}Y_{z}X₆ that are described in EP 3 496 202 A1 as solid-state electrolyte, in which 0<z<2 and X denotes Cl or Br. The lithium yttrium halides may be used as solid-state electrolyte in a lithium ion battery.

The solid-state separator comprises at least one solid-state electrolyte. However, it is also conceivable that two or more different solid-state electrolytes are used.

The solid-state separator preferably comprises one of the abovementioned oxidic solid-state electrolytes, more preferably a lithium-containing garnet such as lithium lanthanum zirconate (LLZO).

The solid-state separator is preferably designed as one layer that may have one or more plies. In particular, there may be two or more plies comprising different solid-state separators. The composition of the plies may vary stepwise or gradually. There is preferably an oxidic solid-state electrolyte disposed on the anode side.

The anode comprises an anode current collector and optionally an anode layer.

The anode current collector may consist of any of the materials for anode current collectors that are known in the art. The anode current collector is preferably manufactured from copper.

The anode layer of the solid-state battery may comprise any of the structures and materials for anodes that are known in the art.

For example, the anode layer may comprise an active anode material and/or a nucleation layer.

In addition, the anode layer may take the form of a composite layer comprising a blend of active anode materials and further components such as binders, conductivity additives and solid-state electrolytes, and combinations thereof.

Finally, the anode layer may be in single- or multi-ply form.

Preferred components for the active anode material in the solid-state lithium ion battery include lithium metal, zinc, magnesium, silver, aluminum, indium, tin, bismuth, silicon, silicon suboxide, graphite, silicon-carbon composite, tin-carbon composite, silicon alloy and lithium alloy, and combinations thereof.

In one embodiment, the anode in the uncharged state after production does not comprise any lithium metal. The lithium metal is deposited on the anode only by a charging operation after the production of the solid-state lithium ion battery.

Therefore, lithium metal is deposited onto the anode current collector or alternatively on a nucleation layer that may be applied to the anode current collector.

However, the nucleation layer, by contrast with the active anode material, is not capable of fully accepting lithium metal deposited at the anode in the course of charging of the solid-state lithium ion battery. For that reason, the nucleation layer fulfills a different function than the active anode material, namely that of controlling lithium deposition at the anode during the charging operation of the solid-state lithium ion battery. This can already be achieved by the use of a nucleation layer having a layer thickness of 1 nm-10 μm, preferably 5 nm-3 μm, more preferably 10-2000 nm. In a further configuration, a porous nucleation layer may be provided.

In general, the nucleation layer may comprise the same components as the above-described active anode material, apart from lithium or lithium alloys.

Suitable examples for the components of the nucleation layer include zinc, magnesium, silver, aluminum, indium, tin, bismuth, silicon, silicon suboxide, graphite, silicon-carbon composite, tin-carbon composite, silicon alloy and combinations thereof.

The cathode comprises a cathode current collector and a cathode layer atop the one cathode current collector.

The cathode current collector may consist of any of the materials known in the art for cathode current collectors. The cathode current collector is preferably manufactured from aluminum.

The cathode layer comprises at least one active cathode material and a first fluorine-containing polymer.

Suitable active cathode materials for the cathode of the invention include lithium cobalt oxide (LCO), lithium nickel oxide (LNO), lithium nickel cobalt aluminum oxide (NCA), lithium nickel manganese cobalt oxide (NMC), lithium- and manganese-rich lithium nickel manganese cobalt oxide or lithium nickel manganese oxide (LMR), lithium manganese oxide (LMO), lithium iron phosphate (LFP), lithium manganese iron phosphate (LMFP), lithium nickel manganese oxide spinel (LNMO) and derivatives and combinations thereof.

In an advantageous development of the invention, the solid-state battery is a solid-state lithium ion battery.

The solid-state lithium ion battery comprises a cathode having a cathode layer comprising an active cathode material and a first fluorine-containing polymer, an anode and a solid-state separator based on a ceramic, especially oxidic, solid-state electrolyte.

In this embodiment, a synergistic effect arises between the cathode of the invention and the ceramic solid-state separator. Firstly, the fluorine-containing polymer enables ionic binding of the cathode to the oxidic separator; secondly, the solid-state separator can be produced separately from the cathode. In other words, the ceramic solid-state separator, especially an oxidic solid-state electrolyte, can be sintered separately at high temperatures and only subsequently combined with the cathode. Consequently, the cathode need not be exposed to high temperatures in the course of production. Nevertheless, the solid-state electrolyte based on a fluorine-containing polymer which is used in the cathode in accordance with the invention means that intimate contact is established with the ceramic solid-state electrolyte.

A further advantageous combination results from the composition of a solid-state lithium ion battery consisting of the above-described cathode, an oxidic solid-state separator and an anode comprising an anode layer, wherein the anode layer comprises a lithium metal.

In this arrangement, the ceramic, especially oxidic, solid-state separator serves as a particularly stable protective layer between the lithium metal of the anode layer and the active material of the cathode layer. It is thus possible to avoid any unwanted reaction between the constituents of the cathode and the lithium metal of the anode. Consequently, no oxidative breakdown takes place on the anode side. On the cathode side, the first fluorine-containing polymer remains intact since it is spatially separated from the lithium metal of the anode by the protective layer. The performance of the solid-state lithium ion battery is thus restricted only slightly, if at all.

The proposed solid-state lithium ion batteries are easy to produce and have improved cycling stability.

The cyclic aging stability of the test cells can be determined via the number of cycles. The test cells are first charged with a constant charging current up to a maximum permitted cell voltage. The upper cutoff voltage is kept constant until a charging current has dropped to an input value or the maximum charging time has been attained. This is also known as I/U charging. Thereafter, the test cells are discharged at a constant discharge current down to a given cutoff voltage. The charging can be repeated depending on the target number of cycles. It is necessary here to choose the upper cutoff voltage and the lower cutoff voltage and the given charging or discharging currents by experimental means. This is also true of the value to which the charging current has dropped.

The invention is described in detail hereinafter by working examples with reference to the appended drawings.

### BRIEF DESCRIPTION OF THE DRAWINGS

FIG. 1: a schematic diagram of a solid-state lithium ion battery comprising only a first fluorine-containing polymer;

FIG. 2: a schematic diagram of the solid-state lithium ion battery from FIG. 1 comprising a second fluorine-containing polymer; and

FIG. 3: a schematic diagram of the solid-state lithium ion battery from FIG. 2 comprising a solvent component.

### DETAILED DESCRIPTION OF THE DRAWINGS

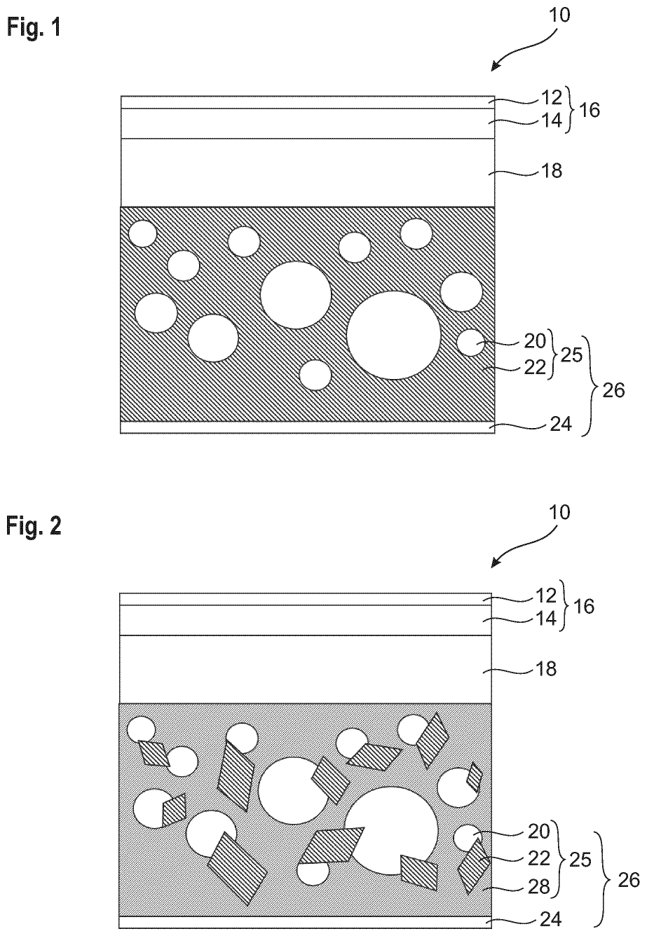

FIG. 1 shows a solid-state lithium ion battery 10. The solid-state lithium ion battery 10 has an anode 16 and a cathode 26. The anode 16 and the cathode 26 are connected to one another in an ion-conducting manner via a solid-state separator 18. In addition, the solid-state separator 18 spatially separates the anode 16 from the cathode 26.

What is meant by “ion-conducting” here is the conduction of lithium ions within the solid-state separator 18.

The anode 16 comprises an anode current collector 12 and an anode layer 14 atop the anode current collector 12.

Anode current collectors are known and typically consist of a metallic material. The anode current collector 12 is intended for electrical contact of the anode layer 14. The anode current collector 12 here may be manufactured from copper, for example.

The anode layer 14 comprises at least one active anode material.

The active anode material is intended to reversibly take up lithium ions and release them again. For this purpose, the active anode material is preferably composed of components from the group consisting of lithium metal, zinc, magnesium, silver, aluminum, indium, tin, bismuth, silicon, silicon suboxide, graphite, silicon-carbon composite, tin-carbon composite, silicon alloy and lithium alloy, and combinations thereof.

The active anode material preferably comprises a lithium metal.

The cathode 26 comprises a cathode current collector 24 and a cathode layer 25 atop the cathode current collector 24.

Cathode current collectors typically consist of a metallic material, for example aluminum.

The cathode layer 25 is in the form of a composite and comprises a blend of active cathode material 20 and a first fluorine-containing polymer 22. In particular, the active cathode material 20 is distributed in a matrix of the first fluorine-containing polymer 22.

The active cathode material 20 is preferably selected from the group consisting of lithium cobalt oxide (LCO), lithium nickel oxide (LNO), lithium nickel cobalt aluminum oxide (NCA), lithium nickel manganese cobalt oxide (NMC), lithium- and manganese-rich lithium nickel manganese cobalt oxide or lithium nickel manganese oxide (LMR), lithium manganese oxide (LMO), lithium iron phosphate (LFP), lithium manganese iron phosphate (LMFP), lithium nickel manganese oxide spinel (LNMO) and derivatives and combinations thereof. The active cathode material 20 is intended to reversibly take up lithium ions and release them again.

The first fluorine-containing polymer 22 has a partly fluorinated or perfluorinated base skeleton and contains at least one ionic group of the general formula (I):

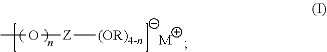

in which
   M is a cation selected from the group consisting of proton and alkali metals;
   n is an integer from 1 to 4;
   Z denotes a central ion selected from the group consisting of aluminum and boron; and
   R represents a monovalent, optionally fluorine-substituted hydrocarbyl radical and is selected from the group consisting of C₁-C₈-alkyl, C₂-C₁₀-alkenyl, C₂-C₁₀-alkynyl, C₆-C₁₂-cycloalkyl and C₆-C₁₂-aryl;
where the ionic group is bonded to the base skeleton of the first fluorine-containing polymer via at least one bridging oxygen atom in the ionic group.

Preferably, in the general formula (I), M is lithium, n is 1 and Z is aluminum. The hydrocarbyl radical R is more preferably a trifluoromethyl radical and/or a perfluoro-tert-butyl radical. Thus, the first fluorine-containing polymer is a lithium ion conductor.

In addition, the cathode layer 25 may comprise at least one binder (not shown here), where the binder is selected from the group consisting of polyvinylidene fluoride (PVDF), hydrogenated acrylonitrile-butadiene rubber (HNBR), carboxymethylcellulose (CMC), styrene-butadiene rubber (SBR), polyacrylate (PAA), lithium polyacrylate (LiPAA) and polyvinylalcohol (PVA), and combinations thereof.

The cathode layer 25 may likewise include a conductivity additive (not shown here), where the conductivity additive is selected from the group consisting of conductive carbon black, carbon nanotubes, graphene, graphite and carbon nanofibers, and combinations thereof.

The solid-state separator 18 is disposed between the anode 16 and the cathode 26, and comprises at least one ceramic, polymer-based or gel-based solid-state electrolyte or combinations thereof.

Solid-state electrolytes used may especially be the following compositions:
a lithium phosphorus sulfide and/or a lithium boron sulfide having the general formula LicTySzRq in which T denotes boron or phosphorus, and R denotes a halogen, and where 2≤c≤7, 1≤y≤7, 3≤z≤13, 0≤q≤1;
a compound of the general formula Li_{1-a-b-c-d}PₐT_{b}A_{c}X_{d} where 0≤a≤0.129, 0≤b≤0.096, 0.316≤c≤0.484, 0.012≤d≤0.125, and in which T denotes an element from the group consisting of As, Si, Ge, Al and B, X denotes one or more halogens or N, and A is one or more of S and Se;
a composition based on lithium (Li), boron (B) and sulfur(S), characterized by a molar a:b:c ratio of Li:B:S, where c/b is within a range from about 1 to about 3;
a lithium-containing garnet having the general formula LiₙLaₘM′ₚM″_{q}ZrₛOₜ in which 4<n<8.5, 1.5<m<4, 0≤p≤2, 0≤q≤2, 0≤s≤2.5 and 10<t≤13, and where M′ and M″ are independently selected from the group consisting of aluminum, molybdenum, tungsten, niobium, antimony, calcium, barium, strontium, cerium, hafnium, rubidium, gallium and tantalum;
a lithium-containing garnet having the general formula Li_{w}LaᵥZrₖOₕ·gAl₂O₃ in which 5≤w≤8, 2≤v≤5, 0≤k≤3, 10≤h≤13 and 0≤g≤1;
a lithium-containing garnet having the general formula LiⱼLa₃Zr_{b}O₁₂·gAl₂O₃ in which 5≤j≤8, 0<b≤2.5, and 0≤g≤1;
an ion-conducting lithium yttrium halide of the general formula Li_{6-3z}Y_{z}X₆ in which 0<z<2 and X denotes Cl or Br;
an ion-conducting polymer based on polyethylene oxide, liquid-crystal polymers, polyetherether-ketone (PEEK), polyphenylene sulfide (PPS) and semicrystalline polymers having a crystallinity of more than 30%, together with a lithium salt, preferably Li₂O, LiTFSI (lithium bis(trifluoromethanesulfonimide)), LiBOB (lithium bis(oxalate) borate) or combinations thereof; and
polylithium acrylate together with a hydrophilic polymer, a lithium salt and a Lewis acid.

The solid-state separator 18 conductively connects the cathode 26 to the anode 16. In particular, the solid-state separator 18 constitutes a protective layer between the anode layer 14 of the anode 16 and the cathode layer 25 of the cathode 26.

The solid-state separator 18 may be in single-ply or more multi-ply form. In particular, two or more plies with different solid-state separators may be present. The composition of the plies may vary stepwise or gradually.

In one embodiment, the solid-state separator 18 may comprise a region disposed on the anode side that has higher stability to lithium metal than a region of the solid-state separator disposed on the cathode side. The region disposed on the anode side preferably comprises an oxidic solid-state electrolyte, more preferably a lithium-containing garnet such as lithium lanthanum zirconate (LLZO). The solid-state lithium ion battery 10 shown here shows particularly good ionic binding of the cathode 26 to the solid-state separator 18. In particular, it is advantageous here that the first fluorine-containing polymer 22 is mechanically flexible and can adapt to the rigid and inflexible form of the solid-state separator 18 and reliably compensate for changes in volume.

FIG. 2 shows the solid-state lithium ion battery 10 from FIG. 1 with an altered composition of the cathode 26.

The cathode 26 in FIG. 2 comprises a cathode layer 25 which is in the form of a composite and comprises a blend of an active cathode material 20, a first fluorine-containing polymer 22 and a solvent component 28.

Furthermore, the solid-state lithium ion battery 10 may contain the same constituents as already described above.

By contrast with FIG. 1, the cathode in FIG. 2 includes a solvent component 28.

The solvent component 28 is preferably selected from the group consisting of perfluorocarbonates, perfluoroaromatics, perfluoroethers and perfluoroesters, and combinations and derivatives thereof.

The solvent component 28 forms a gel electrolyte together with the first fluorine-containing polymer. The gel electrolyte preferably has a gel-like consistency. The gel electrolyte is therefore dimensionally stable, but also mechanically flexible and extensible.

Because of the gel-like consistency, there is good ionic binding between the active cathode material 20 and the gel electrolyte.

Furthermore, there is also ionic binding between the gel electrolyte and the solid-state separator 18.

In addition, the presence of a gel electrolyte having gel-like consistency enables compensation for the expansion in volume of the active cathode material 20 in regular operation of the solid-state lithium ion battery 10.

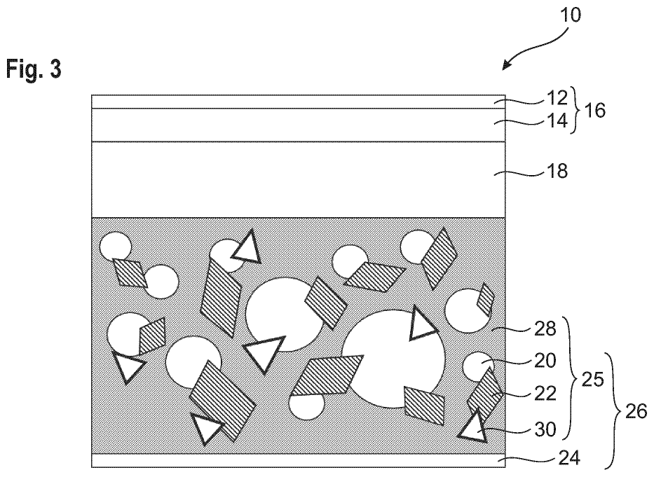

FIG. 3 shows the solid-state lithium ion battery 10 from FIG. 2 with a different composition of the cathode 26.

The cathode 26 in FIG. 3 comprises a cathode layer 25 comprising a blend of a solvent component 28, an active cathode material 20, a first fluorine-containing polymer 22 and a second fluorine-containing polymer 30.

The difference between FIG. 2 and FIG. 3 is thus the presence of a second fluorine-containing polymer in the cathode 26.

Furthermore, the solid-state lithium ion battery 10 may contain the same constituents as already described above.

The second fluorine-containing polymer 30 is preferably selected from the group of the sulfonated perfluorinated polymers having SO₃Li-containing and/or SO₂C(CN)₂Li-containing perfluoroalkyl side chains, preferably a polytetrafluoroethylene (PTFE) such as Nafion, or polymers derived from Nafion. Further possible side chains are SO₂—N⁻Li⁺—SO₂CF₃-containing perfluoroalkyl side chains.

This means that the second fluorine-containing polymer 30 contains perfluorinated side chains saturated with lithium ions. The second fluorine-containing polymer 30 is thus likewise a lithium ion conductor.

The second fluorine-containing polymer 30 preferably forms a gel with the first fluorine-containing polymer 22 and the solvent component 28.

In other words, the active cathode material 20 is in a gel consisting of the first fluorine-containing polymer 22, the second fluorine-containing polymer 30 and the solvent component 28.

The gel enables ionic binding of the active cathode material 20 to the solid-state separator 18 and the cathode current collector 24.

1-10. (canceled)

11. A cathode for a solid-state battery, the cathode comprises the following components:
(A) at least one active cathode material; and
(B) at least one first fluorine-containing polymer having an at least partly fluorinated or perfluorinated base skeleton,
wherein the first fluorine-containing polymer contains at least one ionic group of the following formula (I): 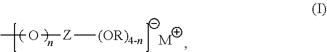
where,
M is a cation selected from the group consisting of proton and alkali metals;
n is an integer from 1 to 4;
Z denotes a central ion selected from the group consisting of aluminum and boron; and
R represents a monovalent, hydrocarbyl radical and is selected from the group consisting of C₁-C₈-alkyl, C₂-C₁₀-alkenyl, C₂-C₁₀-alkynyl, C₆-C₁₂-cycloalkyl and C₆-C₁₂-aryl;
wherein the ionic group is bonded to the base skeleton of the first fluorine-containing polymer via at least one bridging oxygen atom in the ionic group.

12. The cathode according to claim 11, wherein the hydrocarbyl radical R is at least partly fluorine-substituted.

13. The cathode according to claim 11, wherein the hydrocarbyl radical R is fully fluorine-substituted.

14. The cathode according to claim 11, wherein the first fluorine-containing polymer contains at least one ionic end group of the general formula (I) where n=1 and/or at least one ionic crosslinking group of the general formula (I) where n=2, 3 or 4.

15. The cathode according to claim 11, wherein the general formula (I) has one or more of the following features:
Z denotes aluminum;
M denotes lithium; and
R represents a linear, branched or cyclic C₁-C₁₀ perfluoroalkyl radical.

16. The cathode according to claim 11, wherein the general formula (I) has one or more of the following features:
Z denotes aluminum;
M denotes lithium; and
R represents a trifluoromethyl radical.

17. The cathode according to claim 11, wherein the general formula (I) has one or more of the following features:
Z denotes aluminum;
M denotes lithium; and
R represents a perfluoro-tert-butyl radical.

18. The cathode according to claim 11, wherein the base skeleton of the first fluorine-containing polymer has repeat units of tetrafluoroethylene (—C₂F₄—).

19. The cathode according to claim 11, wherein the base skeleton of the first fluorine-containing polymer includes at least one side chain of the general formula (VII) 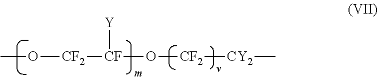
where,
Y denotes a fluorine atom or a linear, branched or cyclic C₁-C₁₀ perfluoroalkyl radical; m is 0, 1 or 2; v is 0 or 1; and
wherein the ionic group of the general formula (I) is bonded to the base skeleton via the CY₂ radical of the side chain.

20. The cathode according to claim 11, wherein the cathode comprises a second fluorine-containing polymer, wherein the second fluorine-containing polymer is selected from sulfonated perfluorinated polymers.

21. The cathode according to claim 20, wherein the second fluorine-containing polymer is selected from the derivatives of polytetrafluoroethylene (PTFE) having SO₃Li-containing, SO₂—N⁻Li⁺—SO₂CF₃-containing and/or SO₂C(CN)₂Li-containing perfluoroalkyl side chains.

22. The cathode according to claim 11, wherein the cathode comprises at least one solvent component, wherein the solvent component is selected from the group consisting of perfluorocarbonates, perfluoroaromatics, perfluoroethers, perfluoroesters, and combinations and derivatives thereof.

23. The cathode according to claim 22, wherein the solvent component forms a gel with the first and/or second fluorine-containing polymer.

24. A cathode for a solid-state battery, the cathode comprises the following components, based in each case on the total weight of the cathode:
(A) 40-98% by weight of at least one active cathode material;
(B) 0.1-30% by weight of at least one first fluorine-containing polymer;
(C) 0-30% by weight of at least one second fluorine-containing polymer, wherein the at least one second fluorine-containing polymer is selected from sulfonated perfluorinated polymers;
(D) 0-70% by weight of at least one solvent component, wherein the at least one solvent component is selected from the group consisting of perfluorocarbonate, perfluoroaromatic, perfluoroether, perfluoroester, and combinations and derivatives thereof;
wherein the proportions of components (A) to (D) add up to 100 percent.

25. The cathode according to claim 24, wherein the at least one second fluorine-containing polymer is selected from the derivatives of polytetrafluoroethylene (PTFE) having SO₃Li-containing, SO₂—N⁻Li⁺—SO₂CF₃-containing and/or SO₂C(CN)₂Li-containing perfluoroalkyl side chains.

26. The cathode according to claim 24, wherein the cathode comprises 0.1-70% by weight of at least one solvent component.

27. A solid-state battery having a cathode according to claim 11, an anode, and a solid-state separator that spatially separates the cathode from the anode and is in ion-conducting contact with the cathode and the anode, wherein the solid-state separator comprises at least one ceramic polymer-based or gel-based solid-state electrolyte or combinations thereof.
